(19) United States
(12) Patent Application Publication
(10) Pub. No.: US 2026/0058033 A1
(43) Pub. Date: Feb. 26, 2026

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); AESC JAPAN LTD., Kanagawa (JP)

(72) Inventors: Kotaro TAKADA, Osaka (JP); Osamu NAKAYAMA, Osaka (JP); Katsushi MIYAZAKI, Osaka (JP); Daiki TSUJI, Osaka (JP); Takami IZAWA, Kanagawa (JP); Masayuki NAKAI, Kanagawa (JP); Yasuhiro YANAGIHARA, Kanagawa (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); AESC JAPAN LTD., Kanagawa (JP)

(21) Appl. No.: 19/117,767

(22) PCT Filed: Sep. 19, 2023
(86) PCT No.: PCT/JP2023/033888

§ 371 Date: Apr. 2, 2025

(30) Foreign Application Priority Data
Oct. 6, 2022 (JP) 2022-161747

(51) Int. Cl. H01B 7/00; H01M 50/503

(52) U.S. Cl. CPC H01B 7/0045; H01M 50/503

(57) ABSTRACT

A wiring module is to be coupled to a power storage component group including power storage components that are arranged. The wiring module includes a connector, electric wires extending from the connector, and a protector having insulating properties and to be attached to the power storage component group. The electric wires include an extra length portion. The extra length portion includes an extending end portion that is disposed close to the connector, a basal portion that is positioned on the protector, and a body portion that is between the extending end portion and the basal portion. The protector includes an extra length portion housing portion in which the body portion is arranged so as to be moved out therefrom and a holder portion that detachably holds the extending end portion or the connector.

### TECHNICAL FIELD

The present disclosure relates to a wiring module.

### BACKGROUND ART

A power storage module that includes a high-pressure power storage group (a battery stack member) is installed in an electric automobile or a hybrid automobile. The power storage group included in such a power storage module includes power storage components that are stacked and are electrically connected to each other in series or parallel. A wiring module that includes electric wires for detecting a voltage and a temperature of each power storage component is attached to the power storage group.

The wiring module, for instance, includes a protector having insulating properties and attached to the power storage group, electric wires held by the protector, and a connector that collectively holds end portions of the electric wires and is connected to a target connector of an external device as disclosed in Patent Document 1. The electric wires that are held by the connector include extra length portions that are not held by the protector so as to extend outward from the protector.

As described in Patent Document 1, the protector includes a connector holding portion that temporally holds the connector that is at ends of the extra length portions such that the connector does not contact with other components with the connector being not connected to a target connector of an external device.

### PRIOR ART

### Patent Document

Patent Document 1: Japanese Unexamined Patent Application Publication No. 2019-36471

### SUMMARY OF THE INVENTION

### Problem to be Solved by the Invention

In such a wiring module, it has not been considered to reduce the contact of the extra length portions connected to the connector and other components when the connector is not connected to the target connector. The length of the extra length portion is determined as appropriate according to usage of the power storage module. Therefore, the extra length portion sometimes becomes longer and may be contacted with external other components (for example, a jig used in assembling) when the power storage module is assembled or just before the power storage module is connected to the external device. If the extra length portion is contacted with other component and receives a force (for example, is pulled), a connection portion of the connector and the extra length portion may be broken.

### Means for Solving the Problem

A wiring module according to the present disclosure is to be coupled to a power storage component group including power storage components that are arranged. The wiring module includes a connector, electric wires extending from the connector, and a protector having insulating properties and holding the electric wires and to be attached to the power storage component group. The electric wires include an extra length portion that includes the electric wires collected into a bundle and that can be moved outside the protector together with the connector. The extra length portion includes an extending end portion that is disposed close to the connector, a basal portion that is positioned on the protector, and a body portion that is between the extending end portion and the basal portion. The protector includes an extra length portion housing portion in which the body portion is arranged so as to be moved out therefrom and a holder portion that detachably holds the extending end portion or the connector.

### Effects of the Invention

According to the present disclosure, a wiring module that reduces contact of an extra length portion and an external other component with a connector being not connected to a target connector is provided.

### BRIEF DESCRIPTION OF THE DRAWINGS

FIG. 1 is a front view of a battery module according to a first embodiment.

FIG. 2 is a perspective view of a front portion of a battery stack member.

FIG. 3 is a perspective view of a portion of a laminated type battery.

FIG. 4 is an enlarged view of an extra length portion housing portion and a holder portion with an extra length portion being therein.

FIG. 5 is an enlarged view of the extra length portion housing portion and the holder portion without the extra length portion.

FIG. 6 is an enlarged perspective view of the extra length portion housing portion and the holder portion with the extra length portion being therein.

FIG. 7 is an enlarged view of an extra length portion housing portion and a holder portion with two extra length portions being therein in a protector of a wiring module according to a second embodiment.

FIG. 8 is an enlarged view of the extra length portion housing portion and the holder portion without the two extra length portions.

FIG. 9 is an enlarged perspective view of the extra length portion housing portion and the holder portion with the two extra length portions being therein.

### MODES FOR CARRYING OUT THE INVENTION

### Description of Embodiments According to the Present Disclosure

First, embodiments according to the present disclosure will be listed and described.
(1) A wiring module according to the present disclosure is to be coupled to a power storage component group including power storage components that are arranged. The wiring module includes a connector, electric wires extending from the connector, and a protector having insulating properties and holding the electric wires and to be attached to the power storage component group. The electric wires include an extra length portion that includes the electric wires collected into a bundle and that can be moved outside the protector together with the connector. The extra length portion includes an extending end portion that is disposed close to the connector, a basal portion that is positioned on the protector, and a body portion that is between the extending end portion and the basal portion. The protector includes an extra length portion housing portion in which the body portion is arranged so as to be moved out therefrom and a holder portion that detachably holds the extending end portion or the connector.

According to such a configuration, the body portion of the extra length portion can be removably arranged in the extra length portion housing portion with the extending end portion of the extra length portion that can extend outward from the protector together with the connector or the connector being held in the holder portion so as to be removed therefrom. In the wiring module having such a configuration, when the connector is not connected to a target connector, the connector is arranged adjacent to the protector and the extra length portion is arranged in and surrounded by the extra length portion housing portion. Therefore, the connector and the body portion are less likely to be contacted with external components.
(2) The extra length portion housing portion preferably includes a bottom portion disposed close to the power storage component group, a wall portion extending outward from the bottom portion, and an orientation adjust portion that extends from at least one of the bottom portion and the wall portion and is contacted with the body portion and adjusts an orientation of the body portion.

According to such a configuration, the body portion of the extra length portion contacts the orientation adjust portion and the body portion can be fit in the extra length portion housing portion with being bent. Therefore, for instance, if the body portion of the extra length portion has a great length, the extra length portion can be arranged in the extra length portion housing portion by using the orientation adjust portion in the extra length portion housing portion.
(3) The holder portion preferably holds the extending end portion detachably, and the protector preferably includes a connector housing portion that has a recessed shape opening outward from the power storage component group side and in which the connector is detachably arranged.

According to such a configuration, with the holder portion holding the extending end portion of the extra length portion, the connector is arranged in the connector housing portion and is surrounded by the connector housing portion and therefore, the connector is less likely to be contacted with external components. Furthermore, according to such a configuration, the connector is less likely to move greatly due to vibration. Therefore, the extending end portion of the extra length portion is less likely to be released from the holder portion by the movement of the connector.

### Details of Embodiments according to the Present Disclosure

Embodiments according to the present disclosure will be described. The present disclosure is not limited to the embodiments. All modifications within and equivalent to the technical scope of the claimed invention may be included in the technical scope of the present invention.

### First Embodiment

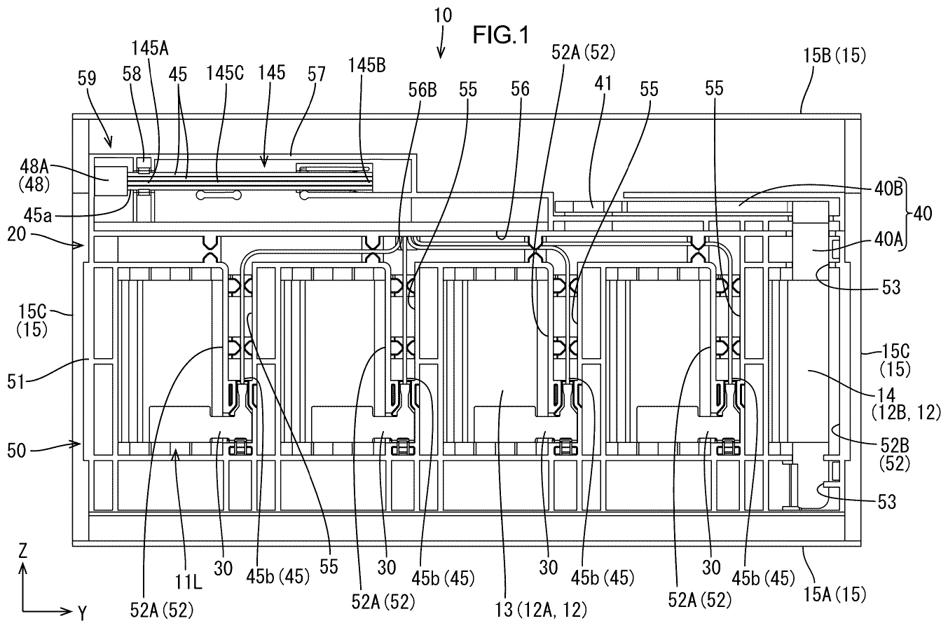

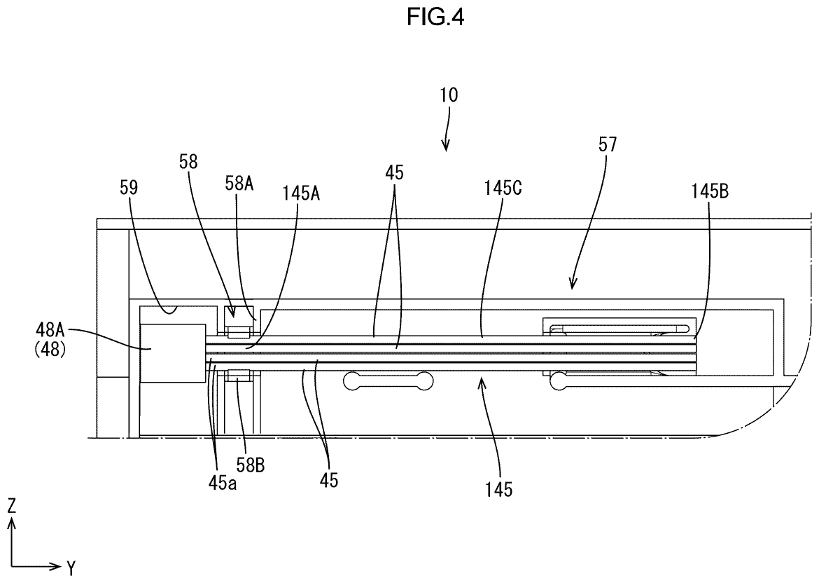

A first embodiment of the present disclosure will be described with reference to FIGS. 1 to 6. A battery module 10 including a wiring module 20 according to this embodiment is installed in a vehicle as a power source for driving a vehicle such as an electric automobile or a hybrid automobile. In the following description, regarding components having the same configuration, some of the components may be indicated by reference signs and others may not be indicated by the reference signs. In this description, it is considered that an X arrow, a Y arrow, and an Z arrow point the front side, the left side, and the upper side, respectively.

### [Battery Module]

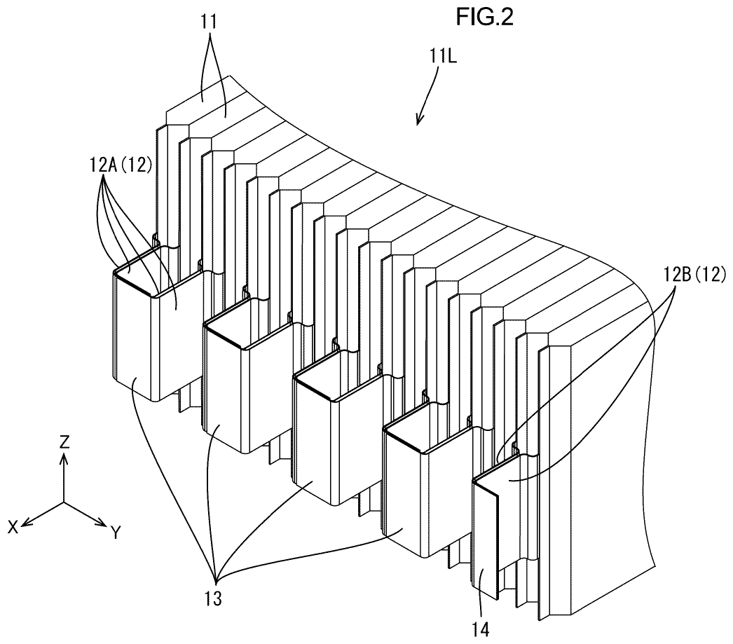

As illustrated in FIGS. 1 and 2, the battery module 10 includes a battery stack member 11L and the wiring module 20 that is attached to the battery stack member 11L. The battery module 10 of this embodiment further includes a casing 15 that covers the battery stack member 11L from four sides, that are from upper, lower, right, and left sides. The casing 15 has a rectangular tubular shape having a substantially rectangular parallelepiped as a whole. The casing 15 includes a bottom portion 15A that is placed on a lower surface side of the battery stack member 11L, a ceiling portion 15B that is placed on an upper surface side of the battery stack member 11L, and a pair of side portions 15C that have a plate shape and connect the bottom portion 15A and the ceiling portion 15B on the right and left sides.

### [Battery Stack Member]

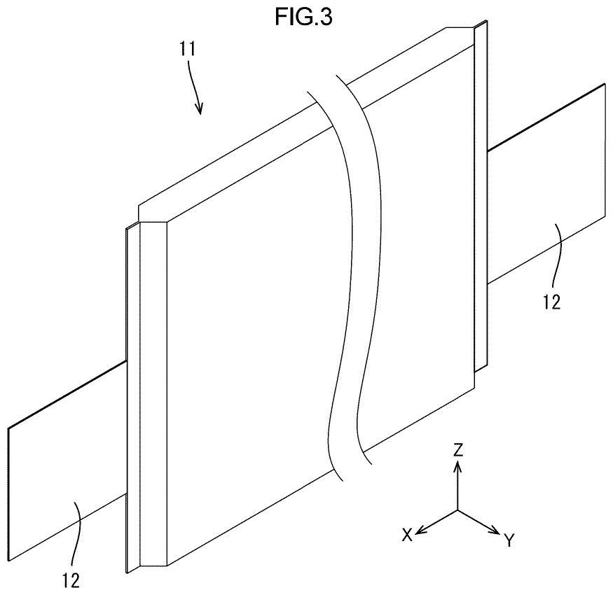

As illustrated in FIG. 2, the battery stack member 11L includes laminated type batteries 11 (power storage components) (eighteen laminated type batteries in this embodiment) that are stacked in a right-left direction. Only a front section of the battery stack member 11L is illustrated in FIG. 2. As illustrated in FIG. 3, the laminated type battery 11 has a flat shape that is elongated in a front-rear direction. The laminated type batteries 11 are arranged such that a thickness direction thereof corresponds to the right-left direction. The laminated type batteries 11 include power storage elements (not illustrated) therein. The laminated type battery 11 includes a pair of electrode leads 12. The electrode leads 12 are on front and rear sides of the laminated type battery 11, respectively, and have different polarities. The pair of electrode leads 12 having different polarities have a plate shape and protrude in opposite directions. Namely, one of the pair of electrode leads 12 protrudes frontward and other one of the pair of electrode leads 12 protrudes rearward.

As illustrated in FIG. 2, the battery stack member 11L includes connection portions 13. The four electrode leads 12 that face the same direction (for instance, a front side) and are arranged adjacent to each other in the right-left direction are electrically connected at the connection portion 13. In forming the connection portion 13, the four electrode leads 12 are divided into two groups with respect to the right-left direction and each of the two groups includes two electrode leads 12. The two electrode leads 12 of each group are overlapped each other and are bent in a same direction at a right angle. More in detail, the two overlapped electrode leads 12 of one of the two groups and the two overlapped electrode leads 12 of other one of the two groups are bent at a right angle such that the distal end portions thereof overlap. The overlapping portions are connected with laser welding and thus, the distal end portions of the four electrode leads 12 are overlapped and connected to each other and configured as the connection portion 13.

In this description, the electrode leads 12 that are configured as the connection portions 13 may be defined as connection electrode leads 12A. Among the four connection electrode leads 12A that are configured as the connection portion 13, the two connection electrode leads 12A that are on the right side and included in one of the two groups and the two connection electrode leads 12A that are on the left side and included in other one of the two groups have opposite polarities. For example, the two connection electrode leads 12A on the right side have a positive polarity and the two connection electrode leads 12A on the left side have a negative polarity. In the battery stack member 11L, several sets each including two laminated type batteries 11 that are connected in parallel are connected series via the connection portion 13. As illustrated in FIG. 2, the battery stack member 11L includes four connection portions 13 on a front section. The battery stack member 11L includes four connection portions 13 (not illustrated) on a rear section.

As illustrated in FIG. 1, the battery stack member 11L includes an output portion 14 on a left edge portion (a right edge portion in FIG. 1) of a front section. The battery stack member 11L also includes the output portion 14 on a right edge portion of the front section, although it is not illustrated. Among the electrode leads 12 that face the same direction (for instance, the front side), the two adjacent electrode leads 12, which are not configured as the connection portion 13, are overlapped and connected and configured as the output portion 14. In this description, the electrode leads 12 that are configured as the output portion 14 may be defined as output electrode leads 12B. The two output electrode leads 12B that are configured as the output portion 14 have a same polarity. The output portion 14 is configured as a positive polarity or a negative polarity of the whole battery stack member 11L. For instance, with the output portion 14 on the front section having a positive polarity of the whole battery stack member 11L, the output portion 14 on the rear section (not illustrated) has a negative polarity of the whole battery stack member 11L.

### [Wiring Module]

The wiring modules 20 are attached to the front section and the rear section of the battery stack member 11L (a power storage component group), respectively. The wiring module 20 illustrated in FIG. 1 is to be attached to the front section of the battery stack member 11L. Such a wiring module 20 includes a connector 48, electric wires 45, and a protector 50. In this embodiment, the wiring module 20 further includes terminals 30 that are connected to the connection electrode leads 12A and a busbar 40 that is connected to the output electrode leads 12B. In the following, a configuration of the wiring module 20 that is to be attached to the front section of the battery module 10 will be described in detail. The wiring module (not illustrated) that is to be attached to the rear section of the battery module 10 has a configuration similar to that of the wiring module 20 to be attached to the front section and will not be described in detail.

### [Connector]

The connector 48 includes a housing 48A that is made of synthetic resin having insulating properties and male terminals (not illustrated) arranged in the housing 48A. The housing 48A is configured as an outer shape of the connector 48 and has a substantially rectangular parallelepiped. The male terminals arranged in the housing 48A are uncovered on an end side of the housing 48A. The connector 48 is detachably fitted to an external target connector including female terminals. The connector 48 is attached to be fitted to the target connector and can be detached (removed) from the target connector by releasing the fitting. The electric wires 45, which will be described later, extend leftward from the connector 48.

The target connector is connected to an electric wire, which is not illustrated, and connected to an external ECU (electronic control unit) via the electric wire. The ECU has a known configuration including a microcomputer and various kinds of components and has a function of detecting a voltage, a current, and a temperature of each laminated type battery 11 and has a function of controlling charging and discharging of each laminated type battery 11.

### [Electric Wire]

As illustrated in FIG. 1, the wiring module 20 includes the electric wires 45. Each of the electric wires 45 is for detecting a voltage of each laminated type battery 11 and has flexibility and an elongated shape. The electric wire 45 includes a core wire having electrically conductive properties and a linear shape and an insulating sheath that covers the core wire. One end portions 45a of the electric wires 45 are collected into a bundle and connected to the connector 48. The one end portions 45a of the electric wires 45 are held by the housing 48A and electrically connected to the male terminals arranged in the housing 48A. Other end portions 45b of the electric wires 45 are connected to the terminals 30, respectively.

The terminal 30 is formed by processing an electrically conductive metal plate. The terminal 30 that is connected to the other end portion 45b of the electric wire 45 is connected to the connection electrode lead 12A. Each of the terminals 30 corresponds to each of other end portions 45b of the electric wires 45. Namely, the wiring module 20 includes multiple terminals 30.

### [Extra Length Portion]

The electric wires 45 include an extra length portion 145 that includes end portions of the electric wires 45 extending from the one end portion 45a side (one end portions) toward the other end portion 45b side (other end portions). The end portions of the electric wires 45 are collected into a bundle and configured as the extra length portion 145. The extra length portion 145 can extend outward from the protector 50 with being connected to the connector 48.

The extra length portion 145 includes an extending end portion 145A that is on the connector 48 side, a basal portion 145B that is positioned on the protector 50, and a body portion 145C that is between the extending end portion 145A and the basal portion 145B.

Portions of the electric wires 45 extending from the extra length portion 145 side toward the end portions 45b of the electric wires 45 (portions of the electric wires 45 extending from the other end portion 45b side toward the one end portion 45a side) are held by the protector 50 with being branched.

The electric wires 45 of this embodiment are used as voltage detection wires for detecting voltages of the laminated type batteries 11.

The busbar 40 has a plate shape and is made by processing a metal plate having electrically conductive properties. As illustrated in FIG. 1, the busbar 40 includes a first portion 40A that is a flat plate extending in an upper-bottom direction and a second portion 40B that is a flat plate extending rightward from an upper end portion of the first portion 40A. The busbar 40 is held in a busbar holding portion 53 of the protector 50. A middle portion of the first portion 40A of the busbar 40 in the upper-bottom direction is connected to the output electrode lead 12B. A busbar side connection portion 41 is at a right end portion of the second portion 40B.

The busbar side connection portion 41 has a plate shape and has an insertion hole (not illustrated) through which a bolt is inserted. The insertion hole is through a middle of the busbar side connection portion 41 in a thickness direction. An external connection terminal (not illustrated) is disposed on the busbar side connection portion 41 and is used for connecting the battery module 10 and an external device. The busbar side connection portion 41 and the external connection terminal that are overlapped are fixed together with the bolt and the busbar side connection portion 41 and the external connection terminal are electrically connected.

### [Protector]

The protector 50 holds the electric wires 45 and is an insulating plate member that is attached to the front section of the battery stack member 11L. The protector 50 is a molded product made of synthetic resin, for instance. The protector 50 has a substantially rectangular shape elongated in the right-left direction seen from the front-rear direction. The protector 50 includes a protector body 51 that is positioned with respect to the battery stack member 11L.

The protector body 51 is a plate shaped portion having a rectangular shape elongated in the right-left direction seen from the front-rear direction. The protector body 51 includes electrode housing portions 52, the busbar holding portion 53 previously described, branch routing portions 55, a collective routing portion 56, an extra length portion housing portion 57, a holder portion 58, and a connector housing portion 59.

In the protector body 51, the electrode housing portions 52 are arranged in a row along the right-left direction. The electrode housing portion 52 is a frame portion surrounding a rectangular opening portion that is through the protector body 51 in the thickness direction (the front-rear direction). The opening portion has an elongated shape extending in the upper-bottom direction. The protector body 51 includes five electrode housing portions 52. Among the electrode housing portions 52, the four electrode housing portions 52 that are sequentially arranged from the right side toward the left side (from the left side toward the right side in FIG. 1) are connection electrode housing portions 52A. The connection electrode housing portion 52A receives and surrounds the connection portion 13 and the connection electrode leads 12A with the connection portion 13 and the connection electrode leads 12A being exposed through the opening portions. One of the electrode housing portions 52 that is on the left end (the right end in FIG. 1) is an output electrode housing portion 52B that receives and surrounds the output electrode lead 12B and the output portion 14 with the output electrode lead 12B and the output portion 14 being exposed through the opening portion.

The five electrode housing portions 52 that include the four connection electrode housing portions 52A and the output electrode housing portion 52B are arranged at intervals in a row along the right-left direction. The branch routing portions 55 is arranged between the adjacent electrode housing portions 52.

As illustrated in FIG. 1, in the protector body 51, the four branch routing portions 55 extend in the upper-bottom direction. The branch routing portions 55 are grooves that are recessed from the front side toward the rear side and extend in the upper-bottom direction. The portion of the corresponding electric wire 45 on the end portion 45b side is arranged in and held by the branch routing portion 55.

The collective routing portion 56 is on the upper side of the electrode housing portions 52 and is a groove extending in the right-left direction as a whole. The collective routing portion 56 is connected and continuous to upper end portions of the branch routing portions 55. The electric wires 45 that are separately arranged in the respective branch routing portions 55 are collected and arranged in the collective routing portion 56. Thus, the portions of the electric wires 45 extending from the extra length portion 145 side toward the end portions 45b of the electric wires 45 are arranged in and held by the collective routing portion 56 and the branch routing portions 55.

The electric wires 45 that are collectively arranged in the collective routing portion 56 extend through an opening 56B in a bottom portion 56A of the collective routing portion 56 to the extra length portion housing portion 57. The electric wires 45 are collected into a bundle in the extra length portion housing portion 57, which will be described later.

### [Extra Length Portion Housing Portion]

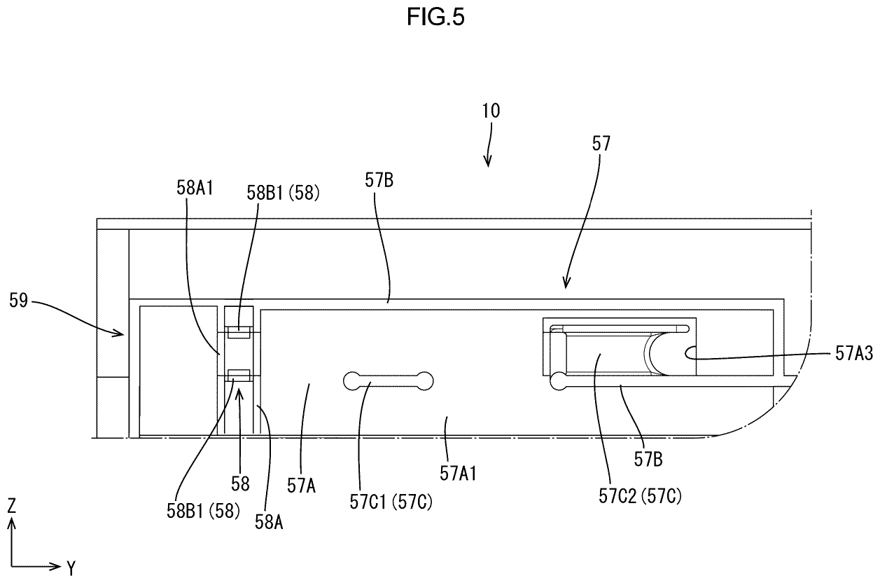

The extra length portion housing portion 57 is above a right portion of the collective routing portion 56. The body portion 145C of the extra length portion 145 is arranged in the extra length portion housing portion 57 so as to be taken out therefrom. The extra length portion housing portion 57 has a container shape extending in the right-left direction and opening frontward as a whole. As illustrated in FIG. 5, the extra length portion housing portion 57 includes a bottom portion 57A that has a plate shape and is disposed on the battery stack member 11L (the power storage component group) side, a wall portion 57B that has a plate shape and extends outward (frontward) from the bottom portion 57A, a first orientation adjust portion 57C1 that erectly extends from the bottom portion 57A, and a second orientation adjust portion 57C2 that erectly extends from the wall portion 57B. In this description, the first orientation adjust portion 57C1 and the second orientation adjust portion 57C2 may be defined as an orientation adjust portion 57C.

The bottom portion 57A has a substantially rectangular shape elongated in the right-left direction seen from the front side. The bottom portion 57A has a front surface 57A1 that faces the front side and a rear surface that is an opposite surface (faces a rear side) from the front surface 57A1. An entry portion 57A3 is in one end portion of the bottom portion 57A with respect to the right-left direction so as to surround a hole that is through in the thickness direction (the front-rear direction). The electric wires 45 of the extra length portion 145 are inserted through the hole, which is surrounded by the entry portion 57A3, in the front-rear direction. As previously described, the electric wires 45 that extend through the opening 56B of the collective routing portion 56 are inserted in the entry portion 57A3 with being collected into a bundle (namely, in a form of the extra length portion). The basal portion 145B of the extra length portion 145 that is inserted in the entry portion 57A3 is in contact with a peripheral edge of the entry portion 57A3 and positioned. Namely, the basal portion 145B of the extra length portion 145 is positioned on the protector 50 side.

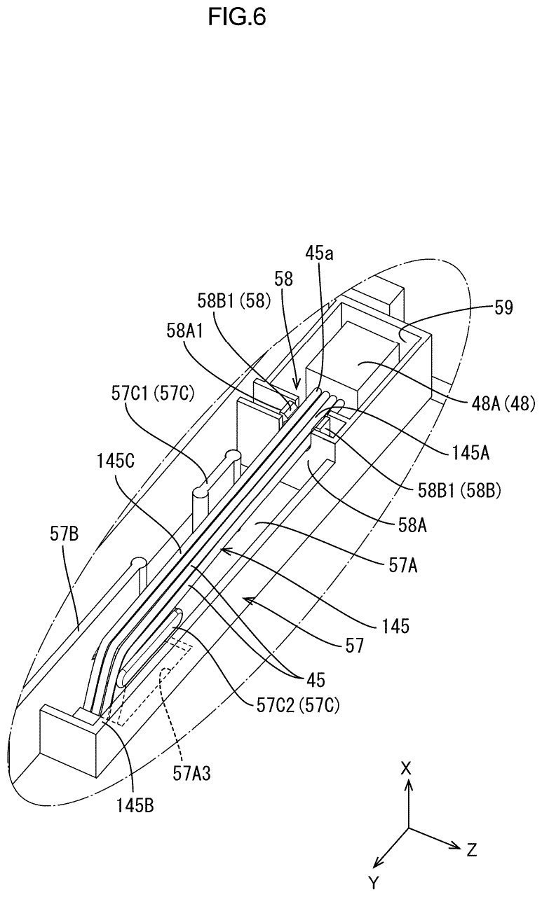

The wall portion 57B erectly extends from a peripheral edge of the bottom portion 57A and a portion of a peripheral edge of the entry portion 57A3. The wall portions 57B are plate members having certain thickness. As illustrated in FIG. 6, the wall portions 57B are arranged to surround the extra length portion 145 (the body portion 145C) that is in the extra length portion housing portion 57.

### [Orientation Adjust Portion]

The first orientation adjust portion 57C1 is a plate piece extending from the bottom portion 57A. With the extra length portion 145 having a long dimension, the extra length portion 145 may be wound around the first orientation adjust portion 57C1 so as to be fit in the extra length portion housing portion 57.

The second orientation adjust portion 57C2 extends erectly from the wall portion 57B with being spaced from the entry portion 57A3 in the front-rear direction and covering the entry portion 57A3. The second orientation adjust portion 57C2 is contacted with the body portion 145C and adjusts the orientation of the body portion 145C such that the body portion 145C of the extra length portion 145 that is inserted through the entry portion 57A3 is fit in the extra length portion housing portion 57 with being bent. More in detail, with the body portion 145C of the extra length portion 145 that is inserted through the entry portion 57A3 coming into contact with an end portion of the second orientation adjust portion 57C2, the routing direction in which the body portion 145C extends is changed.

### [Holder Portion]

The holder portion 58 is adjacent to the extra length portion housing portion 57 and detachably holds the extending end portion 145A of the extra length portion 145. The holder portion 58 includes a support portion 58A and a holding portion 58B. The support portion 58A extends outward (frontward) from the battery stack member 11L (the power storage component group) side and includes a recess portion 58A1 at an extending end thereof. The extending end portion 145A is disposed on the recess portion 58A1. The holding portion 58B holds the bundle of electric wires 45 of the extending end portion 145A that is disposed on the recess portion 58A1 of the support portion 58A. The recess portion 58A1 extends in the right-left direction so as to connect the space in the extra length portion housing portion 57 and the space in the connector housing portion 59. The recess portion 58A1 can receive thereon the extending end portion 145A that extends in the right-left direction. The holding portion 58B includes a pair of plate pieces 58B1. The plate pieces 58B1 are provided on the support portion 58A so as to a space therebetween with respect to the upper-bottom direction and sandwich the extending end portion 145A, which is disposed on the recess portion 58A1, with respect to the upper-bottom direction. With the extending end portion 145A being inserted between the pair of plate pieces 58B1, the plate pieces 58B1 are elastically deformed to increase the space therebetween. With the extra length portion 145 being arranged in the extra length portion housing portion 57 and held by the holder portion 58, the extra length portion 145 is less likely to move out of the protector 50 upward or frontward.

### [Connector Housing Portion]

The connector housing portion 59 has a recessed shape that opens outward from the battery stack member 11L side and the connector 48 is removably arranged in the connector housing portion 59. The connector housing portion 59 is adjacent to the holder portion 58. The holder portion 58 holding the extending end portion 145A of the extra length portion 145 is disposed between the connector housing portion 59 and the extra length portion housing portion 57. With the holder portion 58 holding the extending end portion 145A of the extra length portion 145 and the connector 48 being arranged in the connector housing portion 59, the connector 48 is less likely to move outward (frontward) from the battery stack member 11L side.

### [Arranging and Removing Extra Length Portion in and From Holder Portion and Extra Length Portion Housing Portion]

The battery module 10 including the wiring module 20 is eventually connected to an external device (such as an ECU) via the connector 48. The connector 48 is connected to a target connector of an external device that is away from the wiring module 20 with a certain distance. Therefore, the extra length portion 145 connected to the connector 48 is not held by the holder portion 58 or the extra length portion housing portion 57 and is pulled and moved out of the protector 50. Thus, when the battery module 10 is used, the extra length portion 145 can extend outward from the protector 50 together with the connector 48.

On the other hand, at the time of assembling the battery module 10 or just before the battery module 10 is connected to an external device, the connector 48 is not connected to a target connector. With the connector 48 being not connected to a target connector, the extending end portion 145A of the extra length portion 145 is removably held by the holder portion 58 and the body portion 145C of the extra length portion 145 is arranged in the extra length portion housing portion 57. In this embodiment, with the extending end portion 145A being held by the holder portion 58, the connector 48 connected to the extending end portion 145A is arranged in the connector housing portion 59. Thus, the extra length portion 145 is temporally held by the protector 50 so as not to move out from the protector 50. When the extra length portion 145 is temporally held by the protector 50 as previously described, the extending end portion 145A may be held by the holder portion 58 after arranging the body portion 145C in the extra length portion housing portion 57. Or the body portion 145C may be arranged in the extra length portion housing portion 57 after the extending end portion 145A is held by the holder portion 58.

### Operations and Effects of First Embodiment

According to the first embodiment, operations and effects described below are obtained.

The wiring module 20 according to the first embodiment is to be coupled to the battery stack member 11L including the laminated type batteries 11 that are arranged. The wiring module 20 includes the connector 48 that is detachably fitted to an external target connector, the electric wires 45 that extend from the connector 48, and the protector 50 having insulating properties and to be attached to the battery stack member 11L. The protector 50 holds portions of the electric wires 45 extending from the other end portion 45b side to the one end portion 45a side. The electric wires 45 include the extra length portion 145. The portions of the electric wires 45 extending from the one end portion 45a side toward the other end portion 45b side are collected into a bundle and configured as the extra length portion 145. The extra length portion 145 can extends outward from the protector 50 together with the connector 48. The extra length portion 145 includes the extending end portion 145A that is close to the connector 48, the basal portion 145B that is positioned on the protector 50, and the body portion 145C that is between the extending end portion 145A and the basal portion 145B. The protector 50 includes the extra length portion housing portion 57 and the holder portion 58. The body portion 145C is arranged in the extra length portion housing portion 57 so as to be removed therefrom. The extending end portion 145A or the connector 48 is detachably held in the holder portion 58.

According to such a configuration, the body portion 145C of the extra length portion 145 can be removably arranged in the extra length portion housing portion 57 with the extending end portion 145A of the extra length portion 145 that can extend outward from the protector 50 together with the connector 48 or the connector 48 being held in the holder portion 58 so as to be removed therefrom. In the wiring module 20 having such a configuration, when the connector 48 is not connected to a target connector, the connector 48 is arranged adjacent to the protector 50 and the extra length portion 145 is arranged in and surrounded by the extra length portion housing portion 57. Therefore, the protector 50 and the extra length portion 145 are less likely to be contacted with external components.

The extra length portion housing portion 57 includes the bottom portion 57A that is disposed on the battery stack member 11L side, the wall portion 57B that extends outward from the bottom portion 57A, and the orientation adjust portion 57C that extends from at least one of the bottom portion 57A and the wall portion 57B. The orientation adjust portion 57C contacts the body portion 145C and adjusts the orientation of the body portion 145C such that the body portion 145C is arranged with being bent.

According to such a configuration, the body portion 145C of the extra length portion 145 contacts the orientation adjust portion 57C and the body portion 145C can be fit in the extra length portion housing portion 57 with being bent. Therefore, for instance, if the body portion 145C of the extra length portion 145 has a great length, the extra length portion 145 can be arranged in the extra length portion housing portion 57 with the body portion 145C being bent by using the orientation adjust portion 57C.

The holder portion 58 holds the extending end portion 145A such that the extending end portion 145A can be removed therefrom. The protector 50 includes the connector housing portion 59 that has a recess shape opening outward from the battery stack member 11L side. The connector 48 is arranged in the connector housing portion 59 so as to be removed therefrom.

According to such a configuration, since the connector 48 is surrounded by the connector housing portion 59, the connector 48 is less likely to be contacted with external components. Furthermore, according to such a configuration, the connector 48 is less likely to move greatly due to vibration. Therefore, the extending end portion 145A of the extra length portion 145 is less likely to be released from the holder portion 58 by the movement of the connector 48.

### Second Embodiment

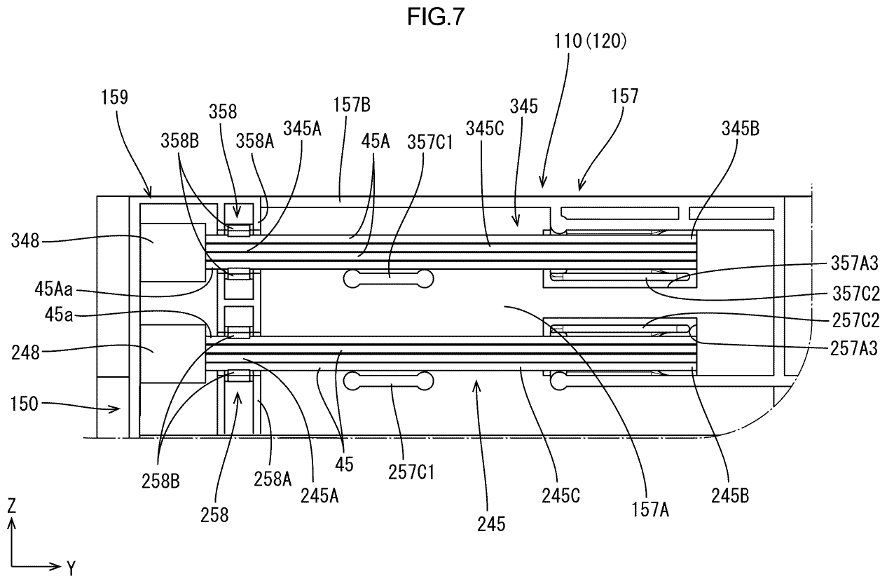

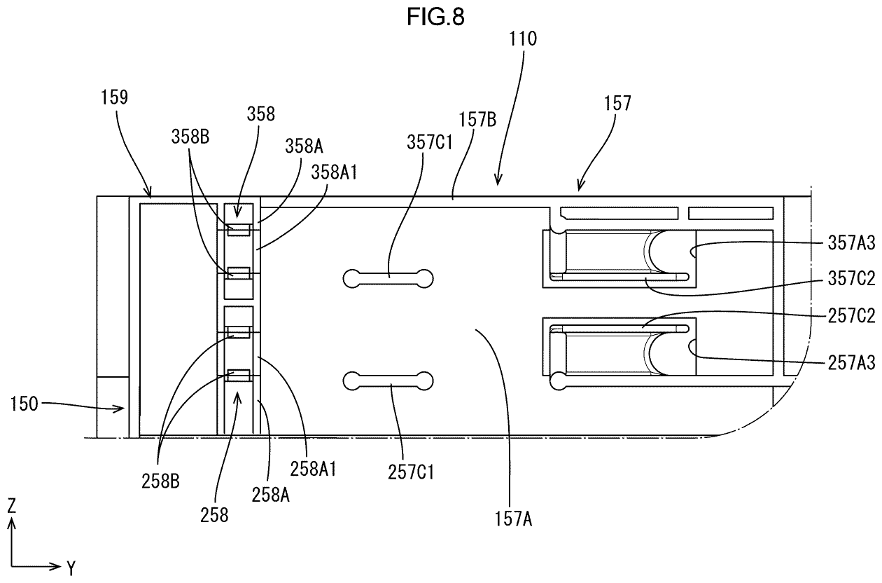

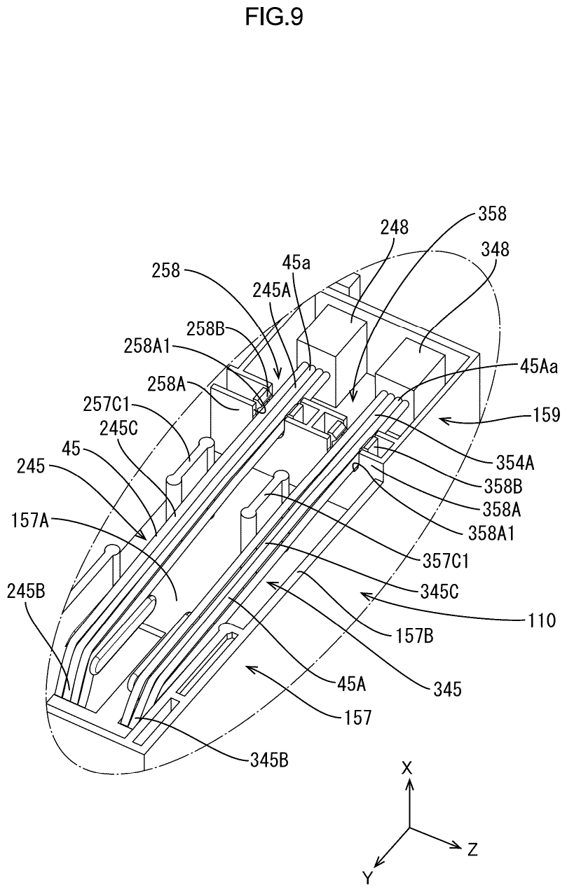

A second embodiment of the present disclosure will be described with reference to FIGS. 7 to 9. The components having the same configuration as those of the first embodiment are indicated by the reference signs of the first embodiment and may not be described. Operations and effects same as those of the first embodiment will not be described. As illustrated in FIG. 7, a battery module 110 according to the second embodiment includes a wiring module 120 including a protector 150. The protector 150 includes an extra length portion housing portion 157 in which two extra length portions 245, 345 are arranged and two holder portions 258, 358 that hold extending end portions 245A, 345A of the extra length portions 245, 345, respectively. The electric wires 45 of one extra length portion 245 are used for detecting voltages of the laminated type batteries (the power storage components) similar to the first embodiment. Electric wires 45A of other extra length portion 345 are connected to a thermistor for detecting temperatures of the laminated type batteries (the power storage components)

The extra length portion housing portion 157 includes a bottom portion 157A and a wall portion 157B. The bottom portion 157A has a plate shape and is disposed on the battery stack member (the power storage component group) side. The wall portion 157B has a plate shape and extends outward (frontward) from the bottom portion 157A. The bottom portion 157A has two entry portions 257A3, 357A3. A basal portion 245B of the one extra length portion 245 is inserted in one entry portion 257A3 and a basal portion 345B of the other extra length portion 345 is inserted in other entry portion 357A3. A first orientation adjust portion 257C1 erectly extends from the bottom portion 157A and is adjacent to the one extra length portion 245. The length of the extra length portion 245 can be adjusted with the first orientation adjust portion 257C1. A first orientation adjust portion 357C1 erectly extends from the bottom portion 157A and is adjacent to the other extra length portion 345. The length of the extra length portion 345 can be adjusted with the first orientation adjust portion 357C1. A second orientation adjust portion 257C2 erectly extends from the wall portion 157B near the entry portion 257A3. The length of the extra length portion 245 can be adjusted with the second orientation adjust portion 257C2. A second orientation adjust portion 357C2 erectly extends from the wall portion 157B near the entry portion 357A3. The length of the extra length portion 345 can be adjusted with the second orientation adjust portion 357C2.

The protector 150 includes the holder portion 258 that holds the extending end portion 245A of the extra length portions 245 and the holder portion 358 that holds the extending end portion 345A of the extra length portion 345. The holder portions 258, 358 include support portions 258A, 358A and holding portions 258B, 358B, respectively. The support portions 258A, 358A include recess portions 258A1, 358A1, respectively. The holding portion 258B includes a pair of plate pieces 258B1 and the holding portion 358B includes a pair of plate pieces 358B1. The protector 150 further includes a connector housing portion 159. A connector 248 from which the extending end portion 245A of the extra length portion 245 extends and a connector 348 from which the extending end portion 345A of the extra length portion 345 extends are arranged in the connector housing portion 159.

### Operations and Effects of Second embodiment

According to the second embodiment, operations and effects described below are obtained.

The protector 150 includes the extra length portion housing portion 157 in which the body portions 245C, 345C of the extra length portions 245, 345 can be arranged and the holder portions 258, 358 that can hold the extending end portions 245A, 345A of the extra length portions 245, 345.

According to such a configuration, with the extending end portions 245A, 345A being held by the holder portions 258, 358, respectively, the two extra length portions 234, 345 can be collectively arranged in the extra length portion 157.

### Other Embodiments

(1) The holder portion of the first and second embodiments holds the extending end portion of the extra length portion such that the extending end portion can be removed therefrom; however, the configuration is not limited thereto. In other embodiment, a protector may include a holder portion that holds a connector so as to be detached therefrom instead of the holder portion holding the extending end portion of the extra length portion.
(2) In the first and second embodiments, the holder portion includes a pair of plate pieces that hold the extending end portion of the extra length portion with respect to the upper-bottom direction; however, the configuration is not limited thereto. The holder portion may have any configuration as long as it can removably hold the extending end portion of the extra length portion.
(3) The body portion of the extra length portion may be bent with being wound around the orientation adjust portion or folded with using the orientation adjust portion to be fit in the extra length portion housing portion.
(4) The laminated type batteries of the battery stack member may be electrically connected by busbars that are held by the protector.

### EXPLANATION OF SYMBOLS

10, 110: Battery module
11: Laminated type battery (power storage component)
11L: Battery stuck member (power storage component group)
12: Electrode lead
12A: Connection electrode lead
12B: Output electrode lead
13: Connection portion
14: Output portion
15: Casing
15A: Bottom portion
15B: Ceiling portion
15C: Side portion
20, 120: Wiring module
30: Terminal
40: Busbar
40A: First portion
40B: Second portion
41: Busbar side connection portion
45: Electric wire
45a: One end portion
45b: Other end portion
48, 248, 348: Connector
48A: Housing
50, 150: Protector
51: Protector body
52: Electrode housing recess portion
52A: Connection electrode housing recess portion
52B: Output electrode housing recess portion
53: Busbar holding portion
55: Branch routing portion
56: Collective routing portion
57: Extra length portion housing portion
57A: Bottom portion
57A3, 257A3, 357A3: Entry portion
57B: Wall portion
57C: Orientation adjust portion
57C1, 257C1, 357C1: First orientation adjust portion
57C2, 257C2, 357C2: Second orientation adjust portion
58: Holder portion
59, 159: Connector housing portion
145, 245, 345: Extra length portion
145A, 245A, 345A: Extending end portion
145B, 245B, 345B: Basal portion
145C, 245C, 345C: Body portion

1. A wiring module to be coupled to a power storage component group including power storage components that are arranged, the wiring module comprising:
a connector;
electric wires extending from the connector; and
a protector having insulating properties and holding the electric wires and to be attached to the power storage component group, wherein
the electric wires include an extra length portion that includes the electric wires collected into a bundle and that can be moved outside the protector together with the connector,
the extra length portion includes an extending end portion that is disposed close to the connector, a basal portion that is positioned on the protector, and a body portion that is between the extending end portion and the basal portion, and
the protector includes an extra length portion housing portion in which the body portion is arranged so as to be moved out therefrom and a holder portion that detachably holds the extending end portion or the connector.

2. The wiring module according to claim 1, wherein the extra length portion housing portion includes a bottom portion disposed close to the power storage component group, a wall portion extending outward from the bottom portion, and an orientation adjust portion that extends from at least one of the bottom portion and the wall portion and is contacted with the body portion and adjusts an orientation of the body portion.

3. The wiring module according to claim 1, wherein
the holder portion detachably holds the extending end portion, and
the protector includes a connector housing portion that has a recessed shape opening outward from the power storage component group side and in which the connector is detachably arranged.
